(19) United States
(12) Patent Application Publication
(10) Pub. No.: US 2006/0196344 A1
(43) Pub. Date: Sep. 7, 2006

(54) Page turning apparatus

(76) Inventor: Bill Wood, Milford, OH (US)

Correspondence Address: SUTHERLAND ASBILL & BRENNAN LLP, 999 PEACHTREE STREET, N.E., ATLANTA, GA, 30309, US

(21) Appl. No.: 11/070,431

(22) Filed: Mar. 2, 2005

(51) Int. Cl. G10G 7/00

(52) U.S. Cl. 84/486

(57) ABSTRACT

The present invention is generally directed to a device to selectively turn pages in a book, magazine, or other publication. The device includes a tapered projection covering a corner of a page with the tapered projection operable rotationally in a plane substantially parallel to the page. The page-lifting arm lifts the page from under the tapered projection such that the page is now on top of the tapered projection. The tapered projection then rotates and turns the page. The present invention also provides for a method of selectively turning pages in a book, magazine, or other publication.

### BACKGROUND OF THE INVENTION

1. Field of the Invention

The present invention is generally directed to page turning methods and devices.

### BACKGROUND

Numerous people have a need for page turning devices. Some of these people are disabled and possibly have limited or no movement of their limbs due to spinal cord injuries, cerebral palsy, multiple sclerosis, or other physical conditions that create a difficulty in their ability to turn a page. Therefore, these people require assistance with turning pages in order to read a book, magazine, or other publication for either business or pleasure. Other people, such as musicians, may require assistance with turning pages in their sheet music or music books while playing instruments.

Previous page turning devices have several disadvantages and drawbacks. Some page turning devices require the placement of a tab on each page to be turned in order to allow the device to manipulate the page. This means that either specially-prepared publications containing tabs must be used with the page turning device or that users must manually insert tabs onto the pages prior to using the page turning device. These preparations require additional costs and time to facilitate the turns of pages. Further, this may limit the types of publications that may be used with the page turning device. Other page turning devices require complex assortments of belts and rollers to operate. Yet other page turning devices, while operating properly in the middle of a book, have difficulty turning the pages at either the beginning or end of the book. Yet other page turning devices only operate with books, magazines, or publications of certain sizes or thickness.

Therefore, it will be appreciated that there is a need for a page turning device requiring minimal preparation that works consistently throughout publications of various sizes and thickness.

### SUMMARY OF THE INVENTION

The present invention is directed towards novel methods and devices for selectively turning pages in books or other publications. More specifically, methods and devices in accordance with the present invention allow for turning pages in variously-sized publications without the use of tabs or other such preparation measures. Further, methods and devices in accordance with the present invention operate consistently from the beginning to end of the publication and even in reverse.

According to one embodiment of the invention, there is a disclosed apparatus for turning a page in a publication with a plurality of pages. The apparatus includes a tapered projection that has its bottom surface positioned over a corner of the page, and the tapered projection can rotate in a plane substantially parallel to the page. The apparatus also includes a page-lifting arm that can operate in a direction substantially perpendicular to the page, where the page-lifting arm lifts the corner of the page from the bottom surface of the tapered projection to a top surface of the tapered projection and the tapered projection subsequently rotates and turns the page.

According to one aspect of the invention, the tapered projection is transparent and may reduce glare. According to another aspect of the invention, the tapered projection may be sized according to the length and width of the page. Similarly, according to another aspect of the invention, the page-lifting arm may be sized according to the length and width of the page. In other words, there may be different sizes of tapered projections and page-lifting arms for different sizes of books, magazines, or other publications. According to yet another aspect of the invention, the page-lifting arm includes an adhesive tip that can removably engage the corner of the page. This adhesive tip may also be replaceable with other adhesive tips.

Furthermore, according to another aspect of the invention, the apparatus may further include a first drive motor for rotating the tapered projection and a second motor for moving an end of the apparatus's page-lifting arm. The second motor may be, for example, a solenoid. According to another aspect of the invention, the apparatus may also include at least one circuit for controlling the first drive motor and the second motor. The at least one circuit may be, for example, a programmable controller. The at least one control circuit can receive input from a user, including through either a blow tube or buttons. If buttons are used, there may be two buttons, a first for moving the end of the page-lifting arm and a second for rotating the tapered projection 180 degrees from an initial position. As a further aspect of the invention, either a third push button or a timer with a specified delay may be used to direct the tapered projection to return to the initial position.

According to another embodiment of the invention, there is disclosed an apparatus for turning a page. The apparatus includes a support board and a page-lifting arm having first and second ends, where the page-lifting arm is coupled at the first end to the support board. The apparatus also includes a motor for pivoting the page-lifting arm such that the second end of the page-lifting arm moves in a direction substantially perpendicular to the support board, a shaft coupled substantially perpendicular to the support board, and a drive for rotating the shaft. The apparatus further includes a plate substantially covering the page or opposing page with a portion of the plate positioned over the comer of the page. In addition, the plate is engaged to the shaft such that the plate is operative rotationally in a direction substantially parallel to the support board. During operation of the apparatus, the page-lifting arm lifts the comer of the page from underneath the portion of the plate to a position above the portion of the plate, and the plate subsequently rotates, thereby turning the page.

According to an aspect of the invention, the plate is transparent and may reduce glare. According to another aspect of the invention, the plate is interchangeable with one of a plurality of plates of different sizes. Similarly, according to another aspect of the invention, the page-lifting arm is interchangeable with one of a plurality of page-lifting arms of various sizes. According to yet another aspect of the invention, the page-lifting arm includes an adhesive tip that can removably engage the corner of the page. The adhesive tip is also replaceable.

Furthermore, according to an aspect of the invention, the apparatus further includes at least one circuit for controlling the drive and the motor. The at least one circuit may be, for example, a programmable controller. The at least one circuit can receive input from a user, including through either a blow tube or at least one button. If buttons are used, there may be two buttons, one for operating the second end of the page-lifting arm and a second for rotating the plate 180 degrees from an initial position. As a further aspect of the present invention, either a third push button or a timer with a specified delay may be used to direct the plate to return to the initial position.

According to yet another aspect of the invention, the apparatus may further include a second page lifting arm and a taper projection possessing two sides, one on each side where a page lifting arm is located. Using a drive motor which rotates both in the clockwise and counter-clockwise directions, the page turning apparatus would allow the pages to be turned in reverse.

According to yet another embodiment of the invention, there is disclosed a method for turning a page. The method includes the steps of placing a tapered projection over a corner of the page, lifting a corner of the page from under the tapered projection, thereby positioning the comer of the page on top of the tapered projection, and rotating the tapered projection and turning the page.

According to an aspect of the invention, the step of placing a tapered projection over a corner of the page includes placing a transparent tapered projection over the corner of the page. According to another aspect of the invention, the step of placing a tapered projection over a corner of the page includes placing a tapered projection that is sized according to a length and width of the page. According to yet another aspect of the invention, the step of lifting a corner of the page from under the tapered projection includes utilizing an adhesive tip to removably engage the corner of the page.

Furthermore, according to an aspect of the invention, the method further includes the step of utilizing at least one control circuit to coordinate lifting the corner of the page and rotating the tapered projection. The at least one control circuit can receive input, including either through a blow tube or at least one button. According to another aspect of the invention, the step of the at least one control circuit receiving input from at least one button includes receiving a first input from a first button, the first input directing the lifting of the comer of the page and receiving a second input from a second button, the second input directing the rotation at the tapered projection 180 degrees clockwise. Further, the step of the at least one control circuit receiving input from at least one button may include receiving a third input from a third button, the third input directing the rotation of the tapered projection 180 degrees counterclockwise. Alternatively, an automatic timer with a specified delay may be used instead of the third input from the third button.

### BRIEF DESCRIPTION OF THE DRAWINGS

Having thus described the invention in general terms, reference will now be made to the accompanying drawings, which are not necessarily drawn to scale, and wherein:

FIG. 1 is a perspective view of a support board, shaft, and page-lifting arm, according to an illustrative embodiment of a portion of the present invention.

FIG. 2A shows a first illustrative example of a sweeping plate.

FIG. 2B shows a second illustrative example of a sweeping plate.

FIG. 3 shows a close-up frontal view of the illustrative embodiment of the present invention prior to initiation of a page turn.

FIG. 4 shows a close-up frontal view of the illustrative embodiment of the present invention after the page-lifting operation is completed.

FIG. 5 shows a close-up frontal view of the illustrative embodiment of the present invention in mid-operation as the page is being turned.

FIG. 6 shows a close-up frontal view of the illustrative embodiment of the present invention after the page is turned.

### DETAILED DESCRIPTION OF THE INVENTION

The present inventions will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

A description of each and every use of a device in accordance with the present invention will be too voluminous to include herein, so the present disclosure is directed to those embodiments and uses that are believed to most clearly represent of the present invention. However, the present invention should not be limited merely to the embodiments and uses disclosed herein, but should be construed to include all of the concepts and teachings disclosed herein.

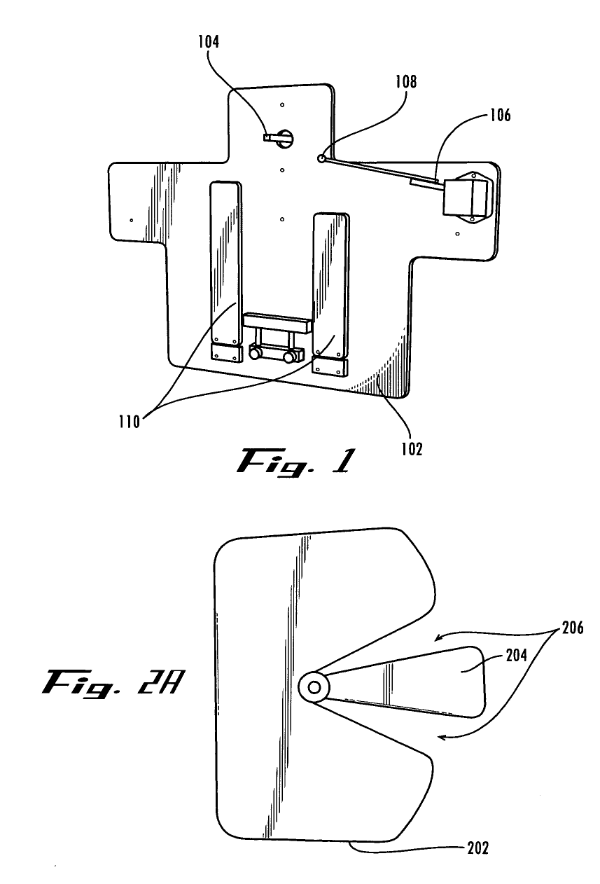

FIG. 1 is a perspective view of a support board 102, shaft 104, and page-lifting arm 106, according to an illustrative embodiment of a portion of the present invention. Support board 102 further includes fasteners 110. As illustrated in FIG. 1, shaft 104 and page-lifting arm 106 are connected to support board 102. In particular, shaft 104 is placed near the top center of support board 102 while page-lifting arm 106 is placed near the top right of support board 102. It will be appreciated, however, that shaft 104 and page-lifting arm 106 may be placed on separate support boards or in different locations on support board 102. It will also be appreciated that page-lifting arm 106 may be interchangeable with other page-lifting arms of different sizes to accommodate publications of various lengths and widths.

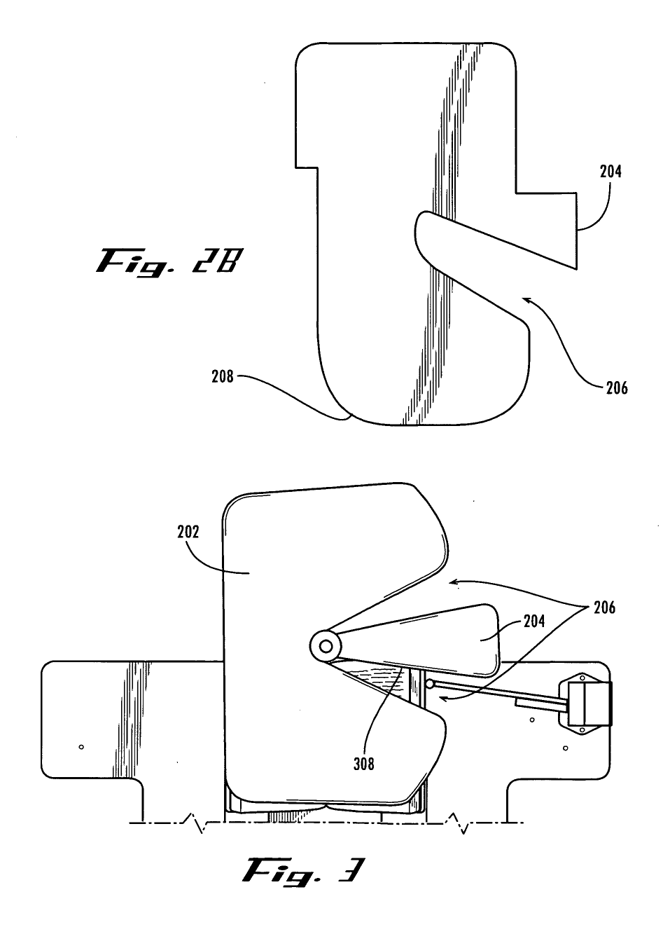

According to one embodiment of the invention, shaft 104 is square-shaped around its circumference, such that the corresponding square hole (not illustrated) in sweeping plate 202 shown in FIG. 2 couples with shaft 104. In addition, shaft 104 is driven at one end by a motor (not illustrated), which may be powered by compressed air or electricity, such that shaft 104 is capable of rotating in either a clockwise or counterclockwise direction. Such motors, including rotation motors and drive systems, are well-known to those of ordinary skill in the art.

As shown in FIG. 1, according to one illustrative embodiment of the invention, page-lifting arm 106 includes an adhesive tip 108. The adhesive tip 108 may be constructed with semi-sticky substances capable of intermittent contact, like the adhesive used in Post-it® notes. Adhesive tip 108 may also be replaceable and interchangeable because the adhesive tips may wear down over time or other adhesive tips of various sizes and stickiness may be required with different publication types. In addition, according to a preferred embodiment of the invention, page-lifting arm 106 is spring-loaded and driven by a solenoid (not illustrated), such that the adhesive tip 108 may be moved in a direction substantially perpendicular to the page and support board 102. When the solenoid is activated, the adhesive tip 108 on page-lifting arm 106 is lowered towards support board 102. When the solenoid is deactivated, page-lifting arm 106 returns adhesive tip 108 to its original position. It is to appreciated that many variations to page-lifting arm 106, including the use of a different type of motor instead of a solenoid, would be apparent to one of ordinary skill in the art.

FIG. 1 also shows fasteners 110 located on support board 102. In a preferred embodiment of the invention, fasteners 110 consist of a set of hinged clamps. The front and back cover of the book or other publication is held by the set of hinged clamps. After the book or other publication is placed in its desired position on support board 102, the clamps are tightened. A variety of other fasteners such as hook-and-loop fasteners may also be used to hold the front and back covers of the book, magazine, or other publication in the desired stationary position.

FIGS. 2A and 2B show two examples of sweeping plates that may be used according to illustrative embodiments of the present invention. One of ordinary skill in the art would readily recognize many variations of these sweeping plates may be used in alternative embodiments of the invention. According to FIG. 2A, sweeping plate 202 includes a tapered projection 204 protruding from aperture 206. Notice that in FIG. 2A, aperture 206 borders tapered projection 204 on both the top and bottom sides. The sweeping plate 202 shown in FIG. 2A may be used to advance pages both forwards and backwards. In FIG. 2B, sweeping plate 202 also includes a tapered projection 204 protruding from aperture 206. However, notice that in the example shown in FIG. 2B, aperture 206 only borders the bottom side of tapered projection 204. The sweeping plate 202 shown in FIG. 2B may be used to advance pages in a single direction. For purposes of illustrating the operation of an embodiment of the invention, the sweeping plate 202 shown in FIG. 2A will be used in the following examples. This selection of sweeping plate 202 in FIG. 2A is not intended to limit the invention to a particular sweeping plate, but is for illustrative purposes only.

In addition, sweeping plate 202, which includes tapered projection 204, is constructed from a thin, disc-like, rigid, transparent material, such as glass, plastic, Plexiglas, and the like. Construction of sweeping plate 202 from a transparent material allows a user to view the page even though sweeping plate 202 may cover a substantial portion of the page. Thus, the transparent material may be specially formulated to reduce glare for a user that is viewing the page through sweeping plate 202. The sweeping plate 202 may cover the entirety of the pages being turned in order to prevent an interruption of sight line while reading. In one embodiment of this invention, the interior edges of the aperture 206, those edges which extend along the interior edge of the aperture 206 across from the tapered projection 204, are curved away from the page being turned. This curved embodiment allows the pages to be turned without interference from the remainder of the sweeping plate 202. In another embodiment of this invention, a raised structure or “dimple” may be positioned on the underside of the tapered projection 204, abutting the page to be turned. This raised structure or “dimple” may be from 1/16 of an inch to ½ of an inch in height off of the underside of the tapered projection 204, preferably ⅛ of an inch to ⅓ of an inch, and most preferably 3/16 of an inch to ¼ of an inch. The raised structure or “dimple” works to depress slightly the open pages of the material to prevent the undesired turning of pages behind the open pages.

FIG. 3 shows a close-up view of an illustrative embodiment of the present invention prior to initiation of a page turn. Sweeping plate 202 has been connected through its square hole (not illustrated) to shaft 104 and is covering a substantial portion of the open book, thereby keeping the pages spread open. According to a preferred embodiment of the present invention, sweeping plate 202 is positioned such that the bottom surface of tapered projection 204 is covering page corner 308.

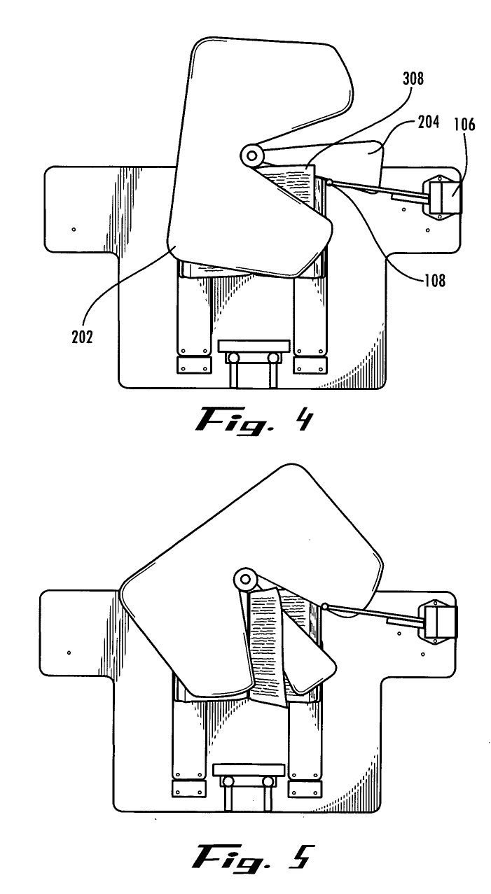

FIG. 4 shows a close-up frontal view of the illustrative embodiment of the present invention after the page-lifting operation has been completed. Here, the solenoid had already activated page-lifting arm 106 to lower adhesive tip 108 to engage page corner 308. The solenoid then deactivated page-lifting arm 106, whereby the adhesive tip 108 lifted page corner 308 from under tapered projection 204 to position page corner 308 above tapered projection 204. Page corner 308 now rests on top of tapered projection 204 as shown in FIG. 4.

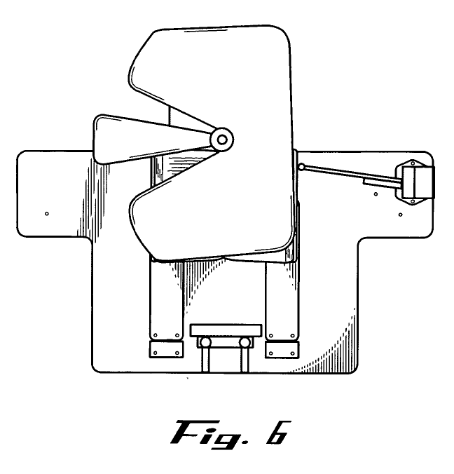

FIG. 5 shows a close-up frontal view of the illustrative embodiment of the present invention in mid-operation as the page is being turned. In a preferred embodiment of the present invention, sweeping plate 202, which includes tapered projection 204, rotates 180 degrees in a clockwise direction, advancing the page forward as shown in FIG. 5.

FIG. 6 shows a close-up frontal view of the illustrative embodiment of the present invention after the page is turned. Here, sweeping plate 202 has finished rotating 180 degrees clockwise. In another embodiment of the invention, there may be a second page-lifting arm placed near the top left of support board 102, operable to lift the top left comer of the page onto tapered projection 204. If sweeping plate 202 is then rotated in the counter-clockwise direction, the page is then advanced backwards. However, according to the preferred embodiment, which only has a single page-lifting arm 106, sweeping plate 202 would be directed to rotate 180 degrees counterclockwise in order to return to its original position, and await a request for advancement of the next page.

In the above illustrative embodiments, no reference has yet been made to how the operations of the shaft 104/sweeping plate 202 combination and page-lifting arm 106 are controlled. However, in a preferred embodiment of the invention, a circuit (not illustrated) controls the operation of the shaft 104/sweeping plate 202 combination and page-lifting arm 106. According to the preferred embodiment, the control circuit receives inputs through three buttons (e.g., pushbuttons or feet-activated pedals), each of which has a separate function. The first button activates the solenoid that operates page-lifting arm 106, including adhesive tip 108. Because page-lifting arm 106 may be spring-loaded, activating the solenoid would lower adhesive tip 108 on page-lifting arm 106. The second button rotates sweeping plate 202 in a clockwise direction. The third button rotates sweeping plate 202 in a counterclockwise direction.

Furthermore, the apparatus could be equipped with a second page-lifting arm, substantially similar to page-lifting arm 106, and a sweeping plate 202 which has a tapered projection 204 and aperture 206 on both sides of the sweeping plate 202 where the page-lifting arms are located. The rotation of the sweeping plate 202 in both the clockwise and counterclockwise directions would allow the user to advance the pages as well as turn the pages back in the direction opposite the advancement through the material held by the apparatus.

During normal operation of the illustrative embodiment, sweeping plate 202 would be placed in (or have returned to) the proper initial position. The user would start by depressing the first button. The solenoid would activate, lowering adhesive tip 108 to engage page corner 308, which is located under tapered projection 204. As the solenoid is deactivated, adhesive tip 108 on page-lifting arm 106 would lift upwards, raising page corner 308 to a position above tapered projection 204. As page-lifting arm 106 finishes lifting adhesive tip 108 upwards, a first normally-open limit switch (not illustrated) is closed by the page-lifting arm returning to its upright position. The closure of the first normally-open limit switch is required before sweeping plate 202 can be rotated. This prevents page-lifting arm 106 from interfering with the rotation of sweeping plate 202.

The user would then depress the second button, which would rotate sweeping plate 202 (including tapered projection 204) approximately 180 degrees clockwise from its initial position until a second normally-open limit switch (not illustrated) is triggered (i.e. closed) by a portion of sweeping plate 202 hitting the limit switch. This normally-open limit switch may also be triggered by a cam fitted to a motor shaft moving the sweeping plate. The rotation of sweeping plate 202 turns the page in the process. When desired, the user would then depress the third button, which would rotate sweeping plate 202 approximately 180 degrees counterclockwise (until a third normally-open limit switch (not illustrated) is closed), returning sweeping plate 202 to its initial position. It should be apparent to one of ordinary skill in the art that many variations of the control circuit are available. For instance, in another embodiment of the present invention, a timer with a specified delay could replace the third button. In that case, when the second button is activated, sweeping plate 202 would rotate 180 degrees clockwise as directed, and then the timer would wait the specified delay time before returning sweeping plate 202, 180 degrees counterclockwise to its initial position. In other embodiments, sweeping plate 202 may simply rotate an additional 180 degrees in the same direction in order to return sweeping plate 202 to its initial position. In other words, instead of first rotating 180 degrees clockwise and then 180 degrees counterclockwise to return to its initial position, sweeping plate 202 may simply rotate an additional 180 degrees clockwise to return to its initial position. Thus, there may only be 2 buttons required for this alternative embodiment. In alternative embodiments, there may only be one button, with programmable logic controllers coordinating the operations of the page-lifting arm 106 and sweeping plate 202. In a further embodiment utilizing programmable logic controllers, depressing the single button operates the page-lifting arm 106 and sweeping plate 202 for as long as the button remains depressed until the cycle has run. If, however, the button is no longer depressed, the page-lifting arm 106 and sweeping plate 202 stop their movements and remain still or return to their respective positions prior to the button being depressed. Similarly, the single button embodiment may have its stop or reversing function engaged by redepressing the button after the cycle has begun. Alternatively, this stop or reversing function may be engaged by depressing another button. Further, this stop or reversing function may be achieved with an apparatus or any number of mechanisms for control, such as merely assigning the stop or reversing function a specific sequence recognized by the logic controller or the mechanism itself being independently capable of performing that task. In addition, the buttons that provide input into the control circuit could be replaced with other input options such as a blow tube device responsive to a puff of air or a sip of air. Further variations may include input through devices that recognize voice commands or eye movements. Additional variations would readily be known to one of ordinary skill in the art.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the present invention may be embodied in many forms and should not be limited to the embodiments described above. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for turning a page of a plurality of pages comprising:
a tapered projection having a bottom surface positionable over the corner of a page wherein the tapered projection is free to rotate in a plane substantially parallel to the page; and
a page-lifting arm, wherein the page-lifting arm is operative in a direction substantially perpendicular to the page;
wherein the page-lifting arm lifts the corner of the page from the bottom surface of the tapered projection to a top surface of the tapered projection and the tapered projection subsequently rotates, thereby turning the page.

2. The apparatus of claim 1, wherein the tapered projection comprises a transparent material.

3. The apparatus of claim 2, wherein the transparent material reduces glare.

4. The apparatus of claim 1, wherein the tapered projection is sized according a length and width of the page.

5. The apparatus of claim 1, wherein the page-lifting arm is sized according to a length and width of the page.

6. The apparatus of claim 1, wherein the page-lifting arm comprises an adhesive tip to removably engage the corner of the page.

7. The apparatus of claim 6, wherein the adhesive tip is interchangeable with other adhesive tips.

8. The apparatus of claim 1, further comprising a first drive motor for rotating the tapered projection and a second motor for moving an end of the page-lifting arm.

9. The apparatus of claim 8, wherein the second motor comprises a solenoid.

10. The apparatus of claim 8, further comprising at least one circuit for controlling the first drive motor and the second motor.

11. The apparatus of claim 10, wherein the at least one circuit comprises a programmable controller.

12. The apparatus of claim 10, wherein the at least one circuit is operable to receive input.

13. The apparatus of claim 12, wherein the input comprises a sip switch.

14. The apparatus of claim 12, wherein the input comprises at least one signal.

15. The apparatus of claim 14, wherein the at least one signal comprises first and second signals, wherein the first button operates the page-lifting arm and the second button rotates the tapered projection from an initial position.

16. The apparatus of claim 15, wherein the tapered projection rotates substantially 180 degrees.

17. The apparatus of claim 15, further comprising a third button that returns the tapered projection to the initial position.

18. The apparatus of claim 15, further comprising a timer that automatically returns the tapered projection to the initial position after a specified delay.

19. An apparatus for turning a page comprising:
a support board;
a page-lifting arm having first and second ends, the page-lifting arm coupled at the first end to the support board;
a motor for pivoting the page-lifting arm such that the second end of the page-lifting arm moves in a direction substantially perpendicular to the support board;
a shaft coupled substantially perpendicular to the support board;
a drive for rotating the shaft; and
a plate substantially covering the page or opposing page, wherein a portion of the plate is positioned over the corner of the page and the plate is engaged to the shaft such that the plate is operative rotationally in a direction substantially parallel to the support board;
wherein the page-lifting arm lifts the corner of the page from underneath the portion of the plate to a position above the portion of the plate and the plate subsequently rotates and turns the page.

20. The apparatus of claim 19, wherein the plate is transparent.

21. The apparatus of claim 20, wherein the transparent plate further comprises glare reduction material.

22. The apparatus of claim 19, wherein the plate is interchangeable with one of a plurality of plates.

23. The apparatus of claim 22, wherein the plurality of plates are of a variety of sizes.

24. The apparatus of claim 19, wherein the page-lifting arm is interchangeable with one of a plurality of page-lifting arms of various sizes.

25. The apparatus of claim 19, wherein the page-lifting arm comprises an adhesive tip to removably engage the comer of the page.

26. The apparatus of claim 25, wherein the adhesive tip is replaceable.

27. The apparatus of claim 19, further comprising at least one circuit for controlling the drive and the motor.

28. The apparatus of claim 27, wherein the at least one circuit comprises a programmable controller.

29. The apparatus of claim 27, wherein the at least one circuit is operable to receive input.

30. The apparatus of claim 29, wherein the input comprises a blow tube.

31. The apparatus of claim 29, wherein the input comprises at least one signal.

32. The apparatus of claim 31, wherein the at least one button comprises first and second signal, wherein the first button operates the page-lifting arm and the second button rotates the plate from an initial position.

33. The apparatus of claim 32, wherein the plate rotates substantially 180 degrees from the initial position.

34. The apparatus of claim 32, further comprising a third button that returns the plate to the initial position.

35. The apparatus of claim 32, further comprising a timer that automatically returns the plate to the initial position after a specified delay.

36. A method for turning a page, comprising the steps of:
placing a tapered projection over a corner of the page;
lifting a corner of the page from under the tapered projection, thereby positioning the corner of the page on top of the tapered projection; and
rotating the tapered projection, thereby turning the page.

37. The method of claim 36, wherein the step of placing a tapered projection over a corner of the page comprises placing a transparent tapered projection over the corner of the page.

38. The method of claim 36, wherein the step of placing a tapered projection over a corner of the page comprises placing a tapered projection that is sized according to a length and width of the page.

39. The method of claim 36, wherein the step of lifting a corner of the page from under the tapered projection comprises utilizing an adhesive tip to removably engage the corner of the page.

40. The method of claim 36, further comprising the step of utilizing at least one control circuit to coordinate lifting the comer of the page and rotating the tapered projection.

41. The method of claim 40, wherein the step of utilizing at least one control circuit comprises receiving input.

42. The method of claim 41, further comprising the step of the at least one control circuit receiving input from a blow tube.

43. The method of claim 41, further comprising the step of the at least one control circuit receiving input from at least one signal.

44. The method of claim 43, wherein the step of the at least one control circuit receiving input from at least one signal comprises receiving a first input from a first button, the first input directing lifting the comer of the page and receiving a second input from a second button, the second input directing rotating the tapered projection 180 degrees clockwise.

45. The method of claim 44, wherein the step of the at least one control circuit receiving input from at least one button further comprises receiving a third input from a third button, the third input directing rotating the tapered projection 180 degrees counterclockwise.

46. The method of claim 44, further comprising the step of utilizing an automatic timer with a specified delay to provide a third input into the at least one control circuit, the third input directing rotating the tapered projection 180 degrees counterclockwise.
